(19) United States
(12) Patent Application Publication
(10) Pub. No.: US 2015/0178680 A1
(43) Pub. Date: Jun. 25, 2015

(54) PATENT PORTFOLIO AGGREGATION, MAPPING AND COLLABORATION PLATFORM HAVING QUALITY ENHANCEMENT PETITION FEATURES

(71) Applicant: Andrew T. Pham, Modesto, CA (US)

(72) Inventor: Andrew T. Pham, Modesto, CA (US)

(21) Appl. No.: 14/580,503

(22) Filed: Dec. 23, 2014

Related U.S. Application Data
(60) Provisional application No. 61/920,712, filed on Dec. 24, 2013.
(60) Provisional application No. 61/920,713, filed on Dec. 24, 2013.

(51) Int. Cl. G06Q 10/10; G06Q 50/18

(52) U.S. Cl. CPC G06Q 10/10; G06Q 50/184

(57) ABSTRACT

Systems, methods and software for aggregating and publishing innovations. In particular, users of this system may submit patent disclosures on various topics or technology areas. The system may then route the idea submissions through the patenting process to relatively rapidly develop a large patent portfolio. In some instances, the submissions may be published to be made accessible by others as part of a first to publish infrastructure. Further, the system may provide back end support for innovation cultivation and harvesting, innovation road mapping and brainstorming, and collaboration.

### CROSS REFERENCE TO RELATED APPLICATION

This application claims priority to, and the benefit of, provisional patent application Ser. Nos. 61/920,712 and 61/920,713, each filed Dec. 24, 2013 and entitled “Patent Portfolio Aggregation, Mapping and Collaboration Platform Having Quality Enhancement Petition Features,” the disclosures of which are incorporated herein by reference in their entireties.

### BACKGROUND

Patents and patent groups are becoming more and more valuable. Sourcing various tasks to large groups of people can foster the creation of relatively large amounts of programs and disclosures. Conventional applications for innovation management are typically document management systems that provide workflow for the receipt and processing of invention disclosures. However, innovation management systems typically do not provide for a global view of how individual invention disclosures relate to each other. Other systems provide for post-filing management of patent applications, such as docketing systems. However, docketing systems often only provide for management of due dates. Thus, conventional applications do not provide a full circle of innovation management that includes harvesting, publication and aggregation of ideas.

### SUMMARY

Systems, methods and software for aggregating and publishing innovations. In particular, users of this system may submit patent disclosures on various topics or technology areas. The system may then route the idea submissions through the patenting process to relatively rapidly develop a large patent portfolio. In some instances, the submissions may be published to be made accessible by others as part of a first to publish infrastructure. Further, the system may provide back end support for innovation cultivation and harvesting, innovation road mapping and brainstorming, and collaboration.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example high-level overview of the subject matter of the present disclosure;

FIG. 2 illustrates a more detailed view of the system of FIG. 1;

FIG. 3 illustrates an aggregation engine and an enterprise engine in greater detail;

FIGS. 4A-4C illustrate an example operational flow of the components within the system of FIG. 1;

FIGS. 5A-5B illustrate example operations performed as part of an invention disclosure submission process;

FIGS. 6A-6D illustrates example IdeaSpace operational flows;

FIG. 7 illustrates an example crowd source operational flow;

FIGS. 8-13, 14A and 14B illustrate example user interfaces associated with the system of FIG. 1;

FIGS. 15A-15D illustrate example operational flows associated with code mapping, scanning, classifying and services; and

FIG. 16 illustrate example computing environments associated with the present disclosure.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While specific implementations will be described below, it will become evident to those skilled in the art that the implementations are not limited thereto.

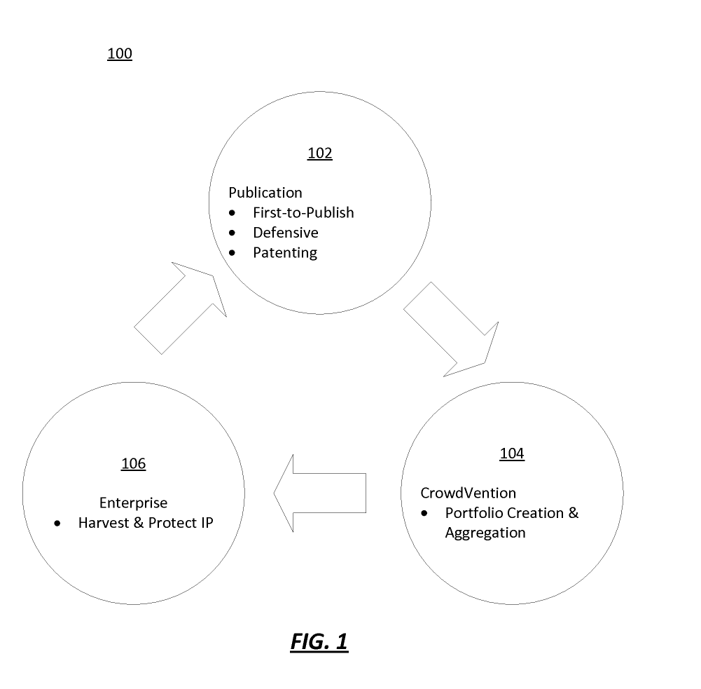

FIG. 1 illustrates an example high-level overview of the subject matter of the present disclosure. In an implementation, the system 100 includes a publication engine 102, an aggregation engine 104 and an enterprise engine 106. The publication engine 102 provides a platform by which innovations may be submitted to the system 100, which are cataloged, and are made available as publications. The publication engine 102 provides a platform by which submissions may be published, thus available as prior art (e.g. as defensive publications).

The aggregation engine 104 receives submissions that are uploaded and are aggregated with other submissions stored by the system 100. The submissions may be processed in order to determine likenesses among the cataloged submissions to provide a map of like submissions. The aggregation engine 104 may also present an overview of the submitted innovations in order to, e.g., suggest combinations of innovations, present trends, etc.

The enterprise engine 106 is a platform by which, e.g., corporate entities may receive and process innovations (e.g., invention disclosures) from individuals. For example, Widget Company may use the enterprise engine 106 to receive invention disclosures from its employees, route them to the appropriate personnel to rate such invention disclosures, and distribute approved invention disclosures to patent practitioners for application drafting and filing. Each of the engines 102, 104 and 106 will be described in greater detail below.

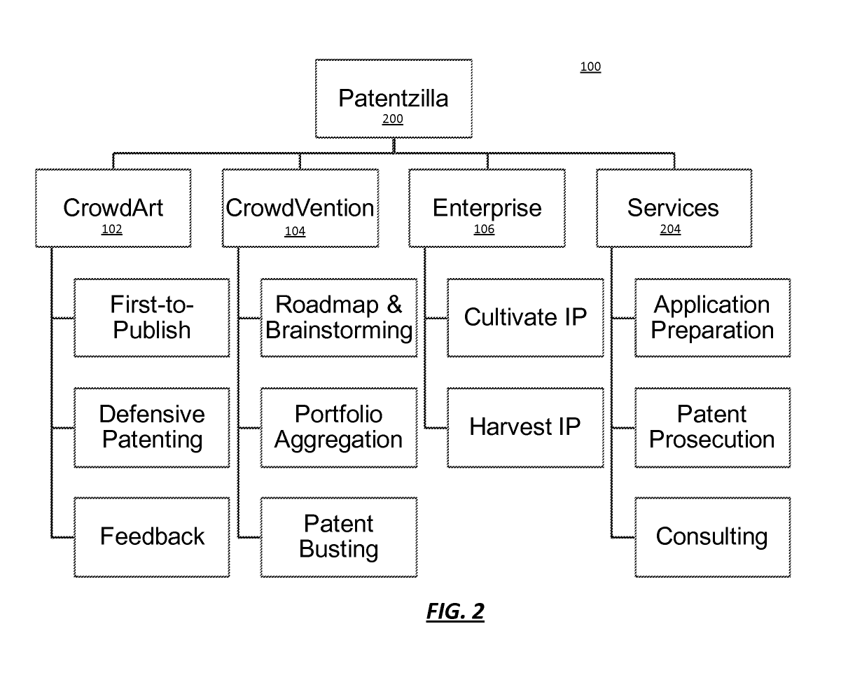

FIG. 2 illustrates a more detailed view of the system 100. The system 100 may be a turnkey solution from PatentZilla, which is a solution provider of the subject matter of the present disclosure. For example, PatentZilla 200 may provide services via a website accessible over the Internet. From a main homepage, the publication engine 102, the aggregation engine 104 and the enterprise engine 106 may be made available to end users. Availability of the PatentZilla website may be either public or by subscription, where access rights are controlled to present predetermined types of information to users (e.g., published information, information designated as confidential, etc.).

As shown, the publication engine 102 provides a “first to publish” platform to enable users or entities to publish innovations in an effort to, e.g., prevent others from patenting the subject matter of such innovations. Similarly, the publication engine 102 provides a defensive patenting platform by which users or entities may submit innovations to be patented. The publication engine 102 may receive feedback from others with regard to the quality of such innovations. The feedback may be submitted by users or entities. For example, the feedback mechanism may enable third-party users to indicate whether an idea, published by an entity using the publication engine 102, is of sufficient value such that it should be protected by patent or other intellectual property mechanisms. The third-party users may provide additional information to enhance the idea.

In accordance with the present disclosure the publication engine 102 provides one or more the following services to enable the user or entity to submit, publish, track, receive feedback, and pay for the use of the publication engine 102:

First-to-Publish

“Defensive Publication”

Authentication and Audit Trail of Publications

Digital Certificates of Publications

Imports of Invention Disclosures (XML files)

Selective fields for publication

Allows Users to Enter Information & Search

Comments, Votes

Allows Conversion into Provisional Patent Application

PDF output for filing

Accepts credit card or PayPal payments

Tracks Usage and Access

The publication engine 102 may be used in the following scenarios by the following entities:

User 1: Corporations

Approved Invention Disclosures (IDs) may be published to win the race to the Patent Office (first-to-publish).

Unapproved IDs may be published for defensive purposes so others cannot obtain patents.

Provide a search mechanism to help corporate user determine patentability of submitted IDs.

Solicit feedback based on anonymous publications.

User 2: Individuals

The individual wants to publish because he/she is not sure if he/she wants to file a patent application.

The individual may not yet have a patent attorney.

This provides the individual with one year to file a patent application.

User 3: Defendants

A litigation defendant wants to search for “prior art” against asserted patents.

User 4: Plaintiffs

A litigation plaintiff wants to search and perform due diligence before asserting a patent.

User 5: USPTO & Other Patent Offices

Competent Patent Offices may desire to search and identify prior art for submitted patent applications.

User 6: PatentZilla

The system 100 may leverage the publications for portfolio creation. The publication engine 102 may provide a facility to upload, import, convert documents in Word, PowerPoint, Abobe PDF, XML. The publication engine 102 may further provide flowchart/drawing tools. Users may be presented a webpage whereby information about the publication such as: a Title, a Summary, Drawings (if any), Body (Detailed Description, Papers), Tags (key words), Category, Technology, Industry, Inventor/Author (can be “Unidentified”), and Company (can be “Unidentified”) may be provided. The publication engine 102 may further provide an API for docketing systems. The publication engine 102 may provide a search facility (described in greater detail below) that enables users to search or browse by technology, by industry, by publication date, and other metadata that may be associated with the publications, such as that described above.

The aggregation engine 104 may provide services such as road mapping and brainstorming, whereby users or entities may map out a plan of innovation. For example, an entity may map out a portfolio filing plan that accounts for anticipated innovations within the entity's research and development group(s). The roadmap may extend for a predetermined period time into the future, such as a year (or longer) in an effort to capture innovations and the anticipated direction of the entity's particular industry or technology.

The brainstorming service may receive raw notes of ideas from, e.g., meetings, to aggregate such ideas into invention disclosures. The patent busting service may be provided to receive prior art and other information in an effort to demonstrate the invalidity of an issued patent. For example, the patent busting service may receive prior art and publications that may be aggregated and presented as part of formal procedure to reevaluate the patentability of issued patent claims.

The enterprise engine 106 provides services to cultivate and harvest intellectual property. Enterprise engine 106 provides a platform by which users may submit ideas for consideration by an enterprise for patenting.

Services 204 represent intellectual property services typically provided by patent practitioners, such as application preparation, patent prosecution, consulting, etc. An output of the system 100 may be a package of innovations based on information provided to the aggregation engine 104 or the enterprise engine 106. The package may be used by the patent practitioners for the purposes above.

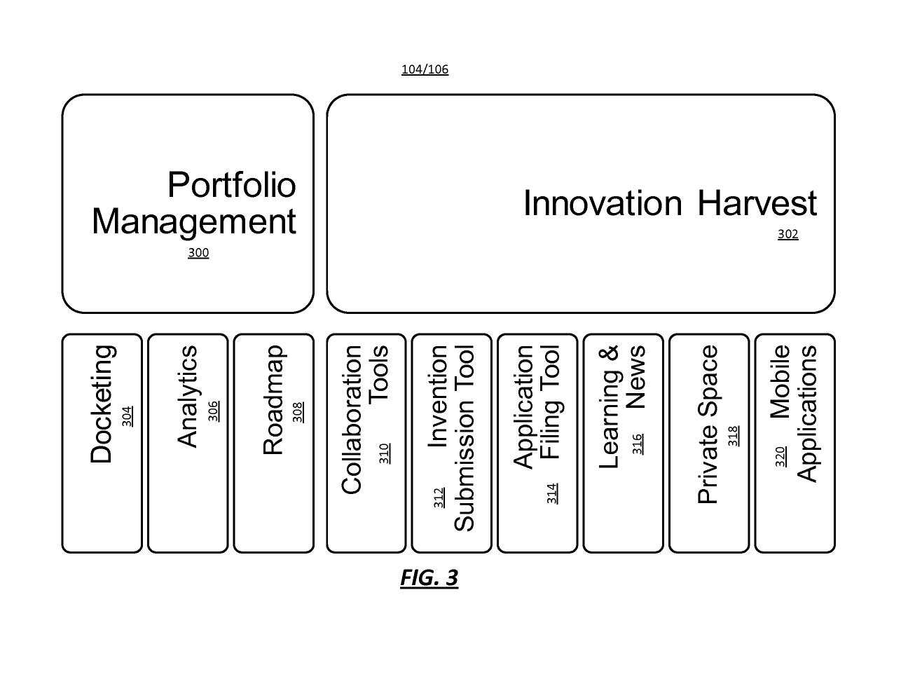

FIG. 3 illustrates the aggregation engine 104 and the enterprise engine 106 in greater detail. The aggregation engine 104 and the enterprise engine 106 may provide portfolio management 300 features such as docketing 304. In addition, the aggregation engine 104 and the enterprise engine 106 may provide for analytics 306 to automatically analyze submissions in accordance with predetermined rules to determine trends, similarities, etc., between submissions in the system 100. A roadmap tool 308 may be provided, as discussed above.

The aggregation engine 104 and the enterprise engine 106 may provide services applicable to innovation and harvesting 302, which cover an inspiration stage, an idea stage and an invention submission stage. In the idea stage, a collaboration/harvesting tool 310 may be provided to flesh out ideas so they may be developed into inventions. The collaboration/harvesting tool 310 may enable users to work together further their ideas. At the invention submission stage, an invention submission tool 312 is provided to receive and process inventions. For example, a form may be provided by which inventors enter information about the invention, as well as details such as dates of conception and reduction to practice, disclosures, etc. Additional details of the invention submission tool 312 are provided below.

The idea stage may provide for interactivity amongst users to enable comments to be provided on submissions. Users may promote their ideas or follow other users' ideas. An “idea cloud” may be created whereby users can tag key terms that are being discussed. A dashboard may be provided of the top idea generators, as well as the hot topics.

The aggregation engine 104 and the enterprise engine 106 may provide further services such as an application filing tool 314 which may build, e.g. provisional applications directly from the submissions. A dashboard and reporting system may be provided to give users a global view of “what's happening” real-time. This may include a learning and news component 316. This may take the form of a selectable and configurable NewsFeed, such as RSS. Private spaces 218 and mobile applications 320 may be provided to disseminate information within private forms and to remote users, respectively. Information may be disseminated such as messages from executives, as well as learning center information, such as basic information about patents, how to brainstorm, how to submit invention disclosures, how to build a patent, and the rewards provided by the system 100.

In accordance with aspects of the present disclosure, the aggregation engine 104 and the enterprise engine 106 may provide a public recognition award system. This may include monetary rewards that are provided at various checkpoints to users.

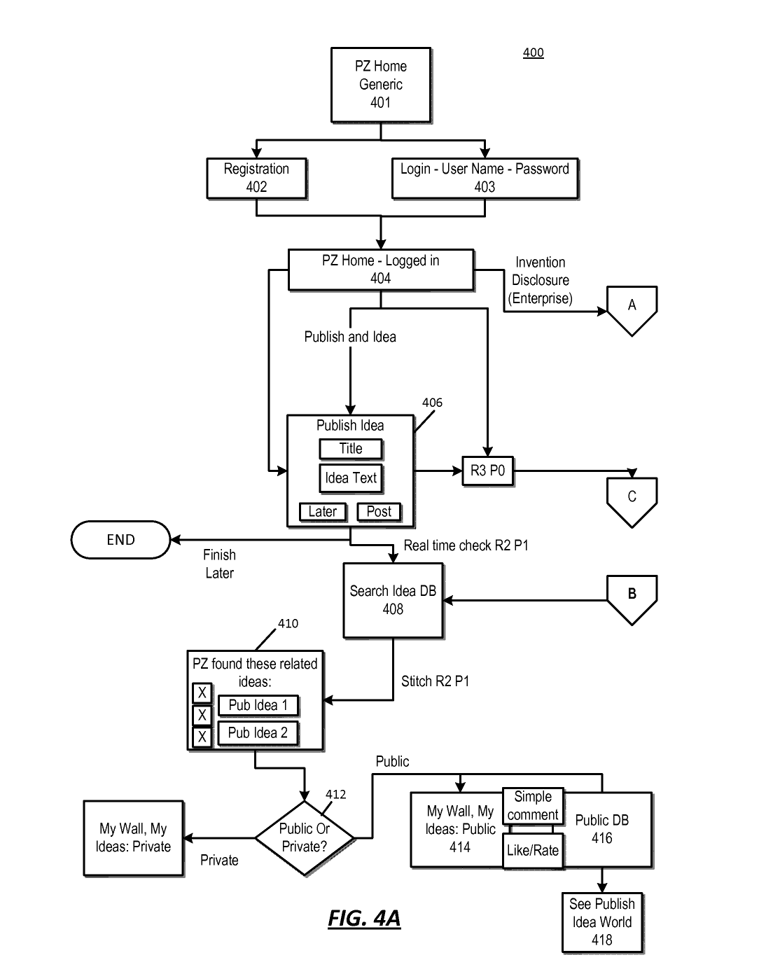

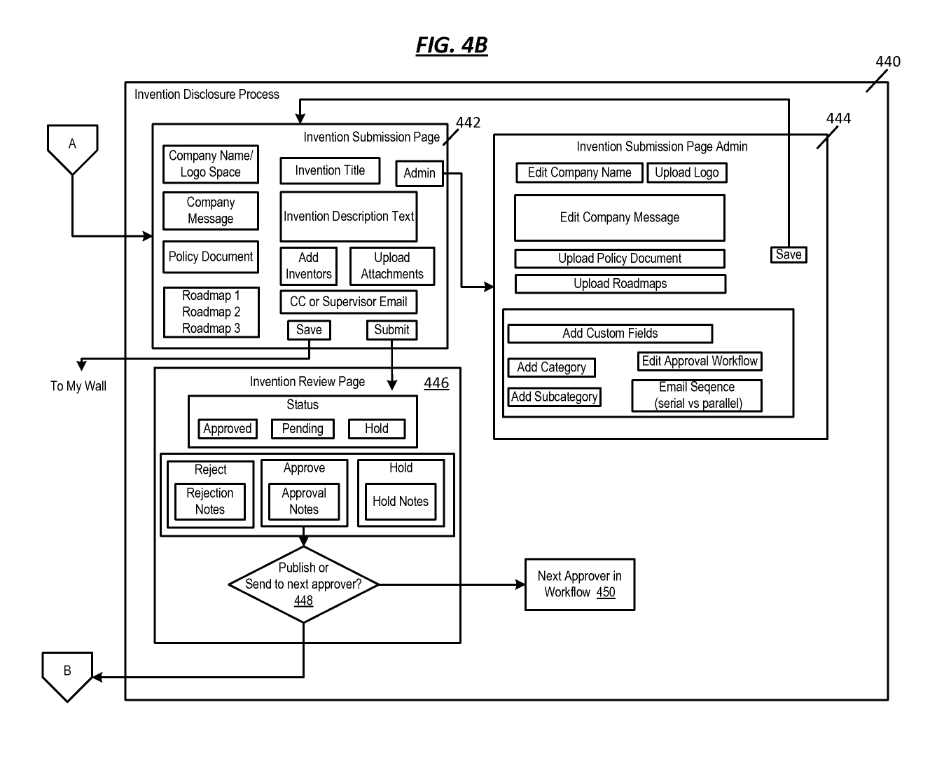

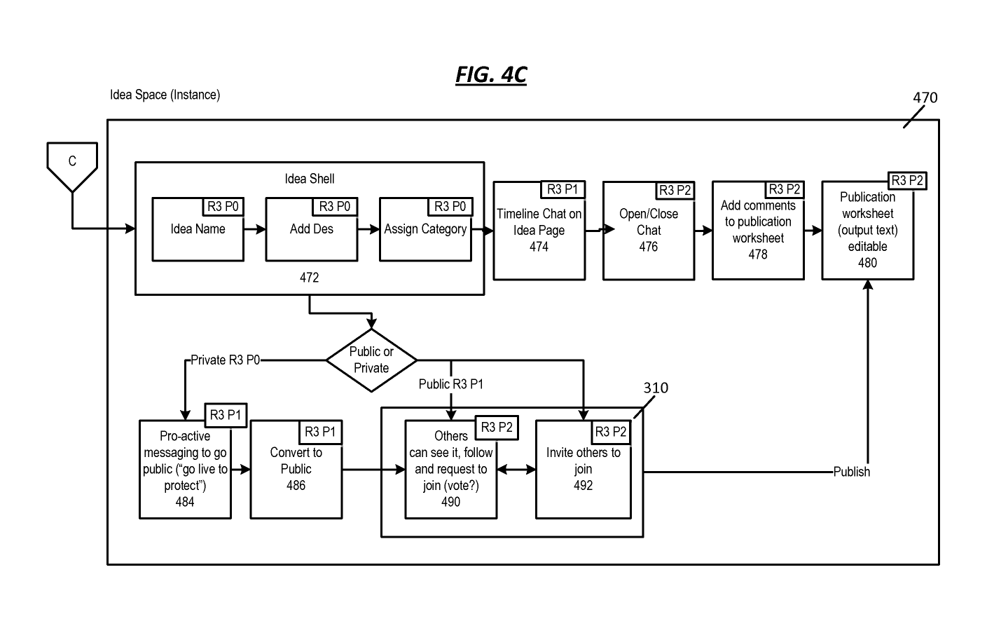

FIGS. 4A-4C illustrate an example operational flow 400 of the components within the system 100. At 401, a generic homepage may be presented to a user that is a frontend to the system 100. Next, a user may register with the system at 402 or log in at 403. At 404, with the user either registered or logged-in to the system 100, frontend webpage may be refreshed to show that the user is now authenticated and ready to interact with the system 100. The user may be provided with various options, such as invoking the publication engine 102, the aggregation engine 104, or the enterprise engine 106 (e.g., the invention submission tool 312).

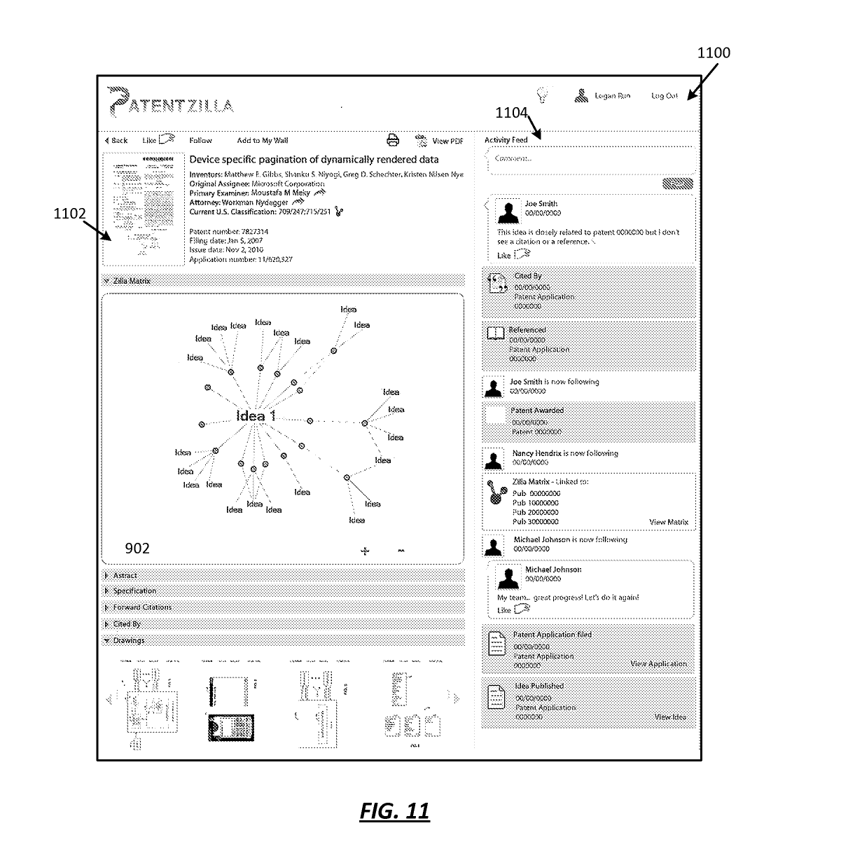

If at 404, the user chooses to submit an invention disclosure (i.e., invoke the invention submission tool 312), processing may continue at 440, as shown in FIG. 4B. At 442, user is presented an invention submission page, which may include a company logo, company message, a policy document, and copies of roadmaps associated with various technologies and/or business units of the company. The user may provide an invention title, descriptive text, and names of other inventors. The user may also upload any documents or attachments associated with invention disclosure. User may also provide an e-mail address of the user's supervisor. The user may save invention disclosure or submit invention disclosure for further processing. If the user saves invention disclosure, user may be returned to the user's “My Wall” webpage, which is described in further detail below with reference to FIG. 11.

If the user submits invention disclosure, then at 446, an invention review page is presented. The invention review page may provide a status of the invention disclosure, such as approved, pending or on hold. Reviewers may be provided options to reject, approve or hold the submitted invention disclosure. At 448, the decision may be made to publish or send invention disclosure to the next approver (if necessary). If the invention disclosure is to be sent to the next approver, then at 450, is routed to the next approver in the approval workflow process. If the invention disclosure is to be published, then at 448 processing continues at 408, described below.

From the invention submission page at 442, an administrative component 444 may be provided, wherein an administrator may update, edit, and delete information. This may include editing the company name, updating the company logo, editing the company message, uploading/updating the policy document, and uploading/updating the roadmaps. The administrator may also access and edit fields, such as categories and subcategories. The administrator may also edit and/or approve approval workflows and an e-mail sequence for notification purposes.

If at 404, if the user chooses to publish an idea (invoke the publication engine 102), then a subsequent webpage may be presented to the user (at 406) to publish his or her idea. As noted above, user may enter information about publication, such as a title, idea text, etc. The user may choose complete the publication process by posting the publication, which submits the publication to a database at 408, thus making the publication searchable by others utilizing the system 100. The user may decide to “finish later,” whereby process will and the user may be returned to the webpage provided at 404.

Once a publication is submitted at 408, further processing may be performed by the system 100. Such processing may include a determination of related ideas within the database (at 410). For example, a database of submissions may be searched for similar information provided by the user at 406 to determine which other publications are related to the submitted publication. Alternatively or additionally, the user may be presented an interface to indicate if other ideas in the database are related to the user's submission.

A determination may be made at 412 if the publication is to be made public or private. This may be in accordance with an indication received from the user or based on a predetermined configuration. If the publication submission is to be made public, it may be written to a public “My wall, My Ideas” space at 414 that is viewable by others. In addition the publication submission may be placed into a publicly accessible database of 416 which is then published for anyone to see or access at 418. The public database may be searchable by search engines, etc. If at 412, the publication submission (and/or results from 410) are to remain private, they may be written to a private “My wall, My Ideas” space. This space would only be accessible by the user and/or those authorized by the user to view the “My wall, My Ideas” space.

Alternatively or additionally at 406, processing may continue at 470 as shown in FIG. 4C. Within the processing block 470, a user may be provided with an idea shell 472 whereby the user inputs an idea name, as descriptions, and assigns category to the submission. At 474, a timeline chat, provided on, e.g., an idea page may be initiated to receive input/comments regarding the submission. The chat may be opened at 476 and available for a predetermined period of time after which it is closed for comments. At 478, the comments received may be added to a publication worksheet, it is made available at 480.

Within the idea shell 472, a decision may be made at 482 whether the idea is to be made public or kept private. If the idea is to be kept private, the user may be proactively requested at 484 to make the submission public, where it is converted at 486 from private to public. The philosophy of the system 100 is to publish submission as they are received, i.e., make as many of the submissions as possible public. Thus, operation 484 is provided. For public submissions at 482, within the collaboration model 310, others may follow, see or request to join the submission at 490. The user-submitter may invite the others to join at 492.

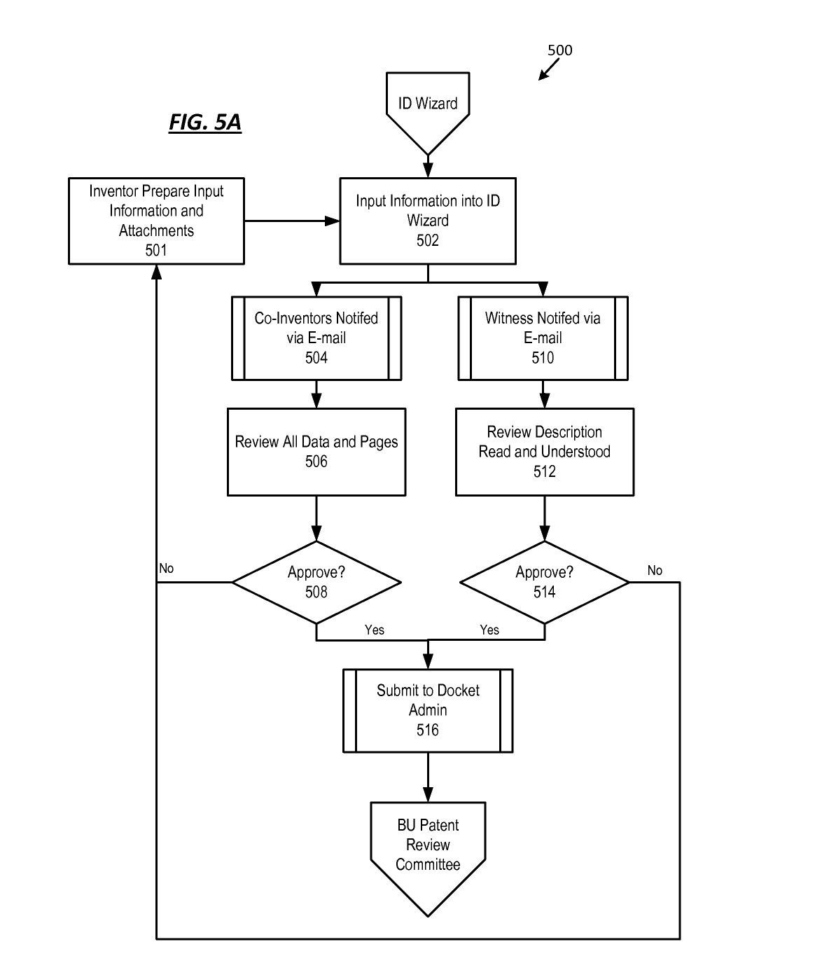

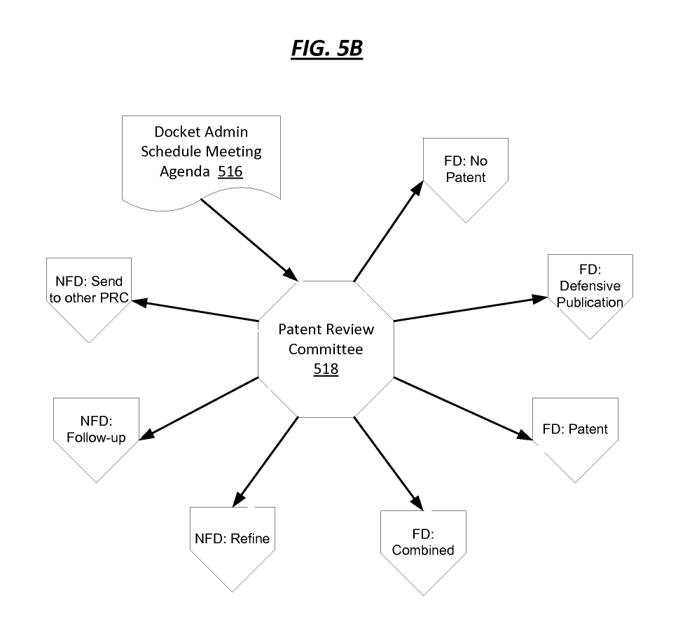

FIGS. 5A-5B illustrate example operations 500 performed as part of the invention disclosure submission process, described above with regard to FIG. 4B. At 502, a user may input information into an invention disclosure (ID) wizard. As described above, at 440, the user submits invention disclosure together with other information about the invention, such as co-inventors, supervisors, etc. This information may be used to route the invention disclosure/submission through workflows for approval and/or publication. For example, at 504 and 510, co-inventors and witnesses may be notified of the invention disclosure submission. While the operation 500 illustrates these processes at 504 and 510 as occurring in parallel, they may be performed serially. At 506 and 512, the co-inventors and the witnesses read invention disclosure. At 508 and 514 the co-inventors and the witnesses approve invention disclosure. If either or both do not approve, then at 501 the inventor may prepare and/or update invention disclosure to include additional information. The updated invention disclosure may be input into the invention disclosure wizard at 502 for further processing.

If at 508 and 514 the witnesses approve, then at 516, the invention disclosure submitted to a docketing administrator for further processing. As shown in FIG. 5B, the docking administrator may schedule a meeting of the patent review committee (PRC) 518. The patent review committee 518 may review and process invention disclosure and determinate a disposition of the invention disclosure. The disposition may include one or more of: not pursuing, making a defensive publication, pursuing a patent, combining with another invention disclosure, refining the invention disclosure, following up with the submitter, or sending to another patent review committee which may have better expertise to review invention disclosure.

Patent Petitions

In accordance with aspects of the present disclosure, a patent petition platform provides gives consumers a way to engage patents that matter to them. The right to petition is a basic worldwide right. The system 100 provides a way to petition patent offices to take action on patents and applications deemed suspect. The patent petition platform gives all consumers worldwide a voice in the patenting process, ensuring the public trust and establishing a system of transparency, public participation and collaboration with patent offices and companies worldwide. It will strengthen the patent system and promote efficiency and effectiveness.

In operation, the patent petition module may identify a suspect patent or application. A petition to have the patent or application rejected is then created. Once a signature threshold is achieved, the system 100 will send a first request to the assignee to pledge it to the public or/and a second request to the Director of the patent office to re-exam and reject it. Such a module provides a mechanism to increase patent quality by providing a voice to consumers.

IdeaSpace/Think Tank

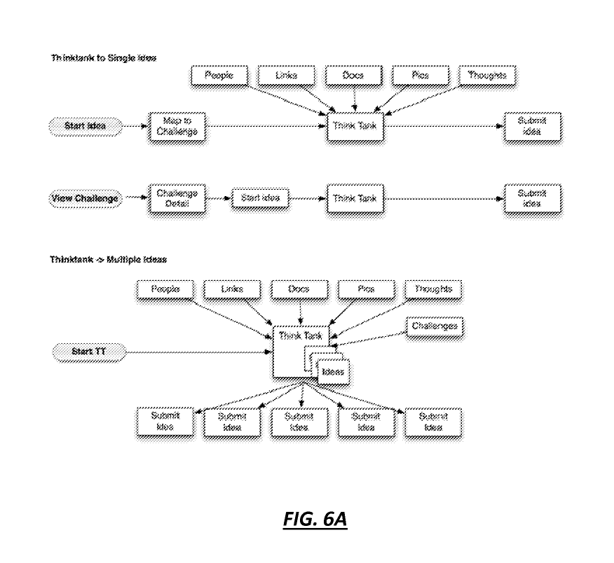

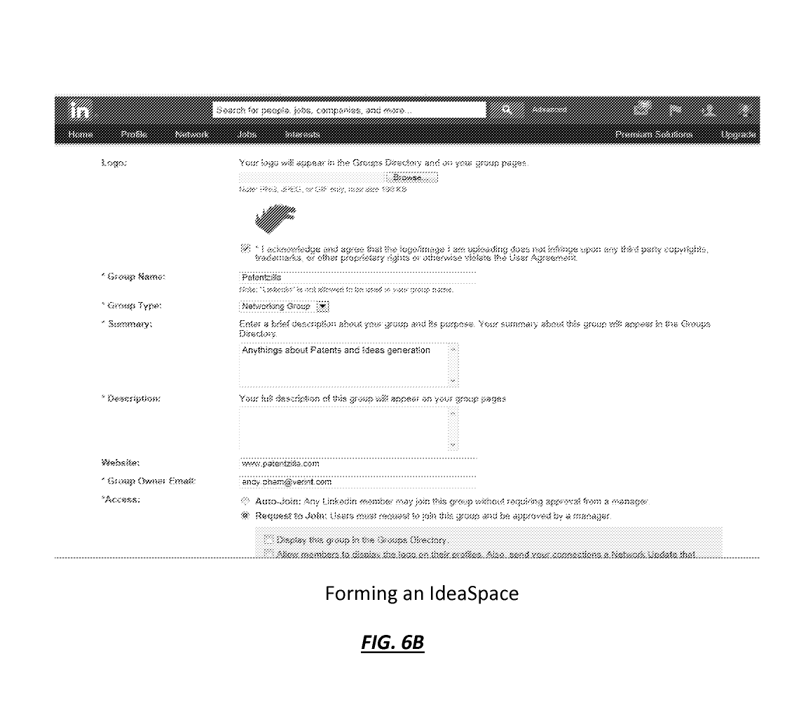

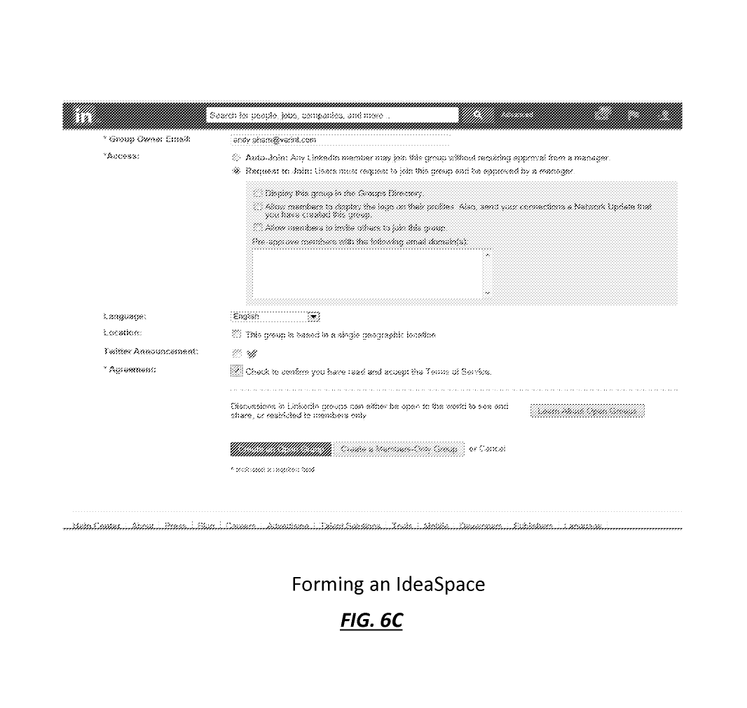

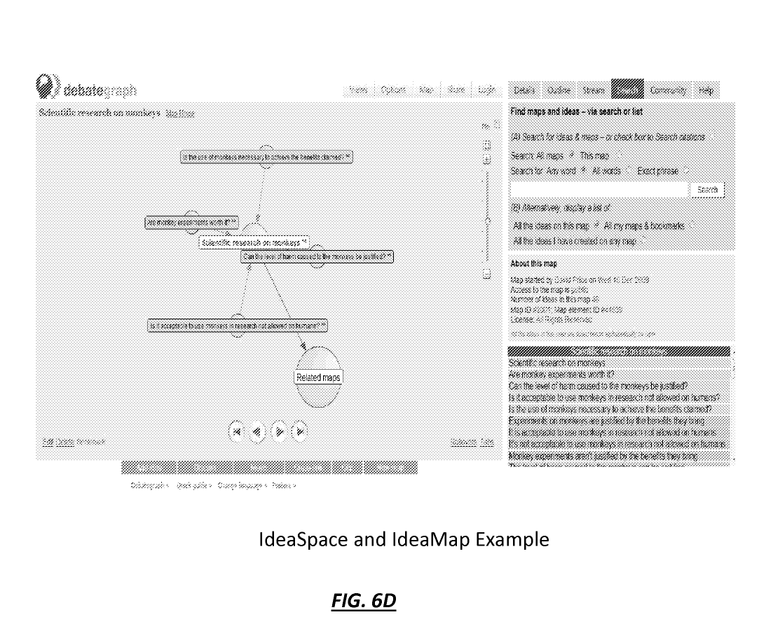

In accordance with an aspect of the present disclosure, an IdeaSpace, or message board, that is dedicated to brainstorming and showcasing ideas and invention is provided where a user can hold conversations in the form of posted messages. The operational flows associated with the IdeaSpace are show in in FIG. 6A. Details of the user interface of the IdeaSpace are shown in FIGS. 6B-6D. Similar to typical message, depending on the access level of a user or the IdeaSpace set-up, a posted message might need to be approved by a moderator before it becomes visible. The IdeaSpace may use the typical hierarchical or tree-like structure, and may contain a number of sub-IdeaSpaces. A single conversation is called a “thread” and can be replied to by as many people as so wish. Depending on the IdeaSpace's settings, users can be invited to private IdeaSpace or request to join public IdeaSpace.

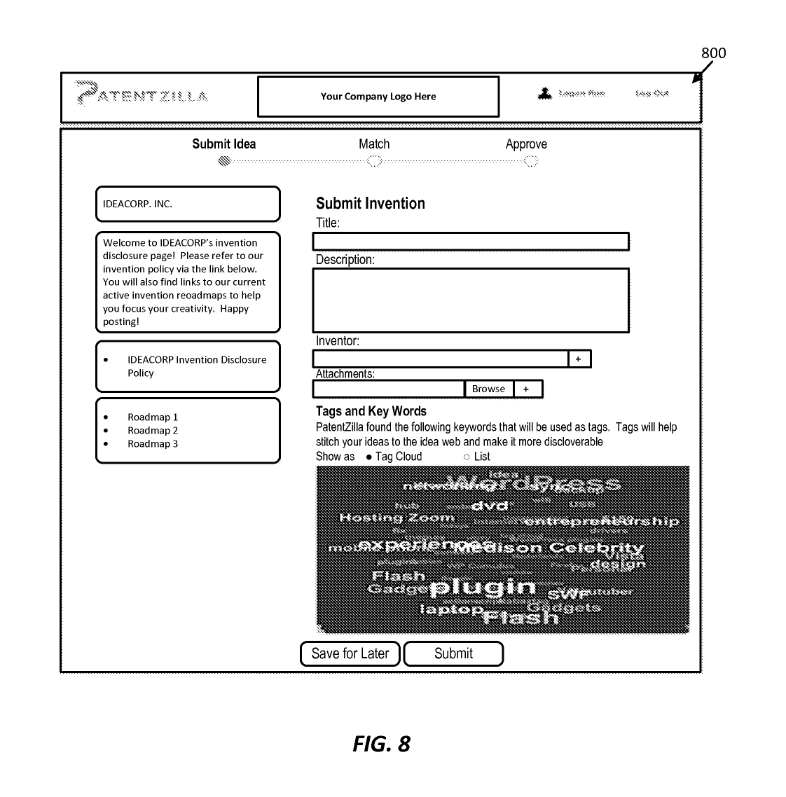

In one aspect, the IdeaSpace includes an IdeaMap, as shown in FIGS. 6D and 9. More specifically, postings with a thread are mapped and related threads from the same IdeaSpace or different IdeaSpace(s) are also mapped. This features allows users to jump from “space to space” or thread in totally different IdeaSpace.

IdeaSpace Innovation with IdeaMap

The IdeaSpace offers individuals and communities a powerful way to learn about, response to, deliberate and decide on ideas and idea direction. The basic elements of message boards are used; however, they are augmented with visualization and interaction layers—the IdeaMap 902—which that will enable users and communities to externalize, visualize, and evaluate all ideas and connected ideas that any member thinks may be relevant to the idea thread (topic) at hand. Intelligent and constructive dialogue facilitates the above using IdeaSpaces style posting similar to Linkedin Group and Podio WorkSpace. Although the IdeaSpace can be private, each public IdeaSpace and its associated IdeaMap will contribute to and form part of an accumulating MAP of structured understanding across IdeaSpaces and wide variety of threads within a wide variety of IdeaSpaces. As idea threads intersect (within the same IdeaSpace or in different or overlapping IdeaSpaces), the idea is accelerated and enriched with each user understanding and thought. For example, separate IdeaMaps 902 developed by experts on mobile gaming intersect, as cross-links between the IdeaMaps 902 for PC gaming or console gaming. The specialized knowledge and ideas from different domain come to be seen to be part of a systemic map.

Brainstorming in a structured and transparent form with IdeaMap allows users to see how their ideas are related, overlap, connect to, or novel in view of other ideas. The IdeaMap 902 within the IdeaSpace will allow a user to see, for example, context, fill any gaps, expand upon, improve, and challenge any ideas. The more that people contribute their own ideas, the greater the network benefits for all the communities—and whether the communities are small teams, organizations, network of stakeholders, or societies as a whole, the ability to augment our individual capacity to brainstorm in the face of changing and gaming technologies, we confront today's society needs more efficiently and collectively—that is, accelerate innovation.

Thus, the IdeaSpace creates a new kind of public service that enables local and global communities of people to think together by collaboratively building and editing comprehensive and succinct maps of complex ideas that accurately present all creative ideas around the world, free of repetitive clutter and ‘noise.’ With each new posting, all aspects of the IdeaMap 902—both their content and structure—are continuously open to revision, refinement, comment, and evaluation by anyone who wants to join the community of thought. Each map is a cumulative work in progress that can be edited and expanded.

The IdeaMap 902 multi-dimensional to reflect the nuances of ideas and ideas “forking” rather than being limited to one dimensional good and bad ideas and can be clustered into overlapping ideas. Viewers and contributors can explore the top-level structure of ideas and delve onto specific strands or sub-structures of an idea, without losing sight of the overall semantic whole or category. Updates and email alerts are available to keep everyone up to date with changes as an idea evolves, each element on a map has its own comments section to allow for open discussion and brainstorming. Each idea on the map can be rated—enabling the map to be used as a kind of multi-dimensional poll or decision making tool—and the map visualizations change automatically to reflect the perceived “strength” of each idea (e.g., Node size changes by the number of “Liked”). Every part of every map has a direct URL associated with it; so viewers can be pointed towards the IdeaSpace and thread.

IdeaSpace Structure
The basic IdeaSpace structure consists of a tree like directory structure. The top end is “Thread.” Although traditional IdeaSpaces can be divided into categories for the relevant discussions, the IdeaSpace will implement this via Sub-IdeaSpace. For example, the IdeaSpace will have the following structure:

IdeaSpace
Sub-IdeaSpace, if any
   Topic (Like, Follow, Comment, Fork)
   Reply (Like, Hitch)
   Reply (reply to main topic only. There is no reply to reply)
Topic (Like, Follow, Comment, Fork)
   Reply (Like, Hitch)
Reply (reply to main topic only. There is no reply to reply)

The topics (or threads or idea posting) are where users start a discussion on an idea. Logically IdeaSpaces are organized into a finite set of generic Sub-IdeaSpaces (usually with one main category for the IdeaSpace) driven and updated by a group known as members, and governed by a group known as moderators. The IdeaSpace will incorporate the IdeaMap visualization and interaction tool as described above.

User Groups

Members of an IdeaSpace may be organized into user groups/Roles. Privileges and rights are given based on these groups. A user of an IdeaSpace can automatically be promoted to a more privileged user group based on criteria set by the administrator or manager. For example, a person viewing a closed thread (closed by the owner/original poster or admin or manager) as a member will see a box saying he does not have the right to submit messages there, but a moderator or manager will likely see the same box granting him access to more than just posting messages.

An unregistered user of the system 100 may be a guest or visitor. Guests are typically granted access to all functions that do not require database alterations or breach privacy. A guest can usually view the contents of the IdeaSpace or use such features as navigating the IdeaMap.

Moderators

The moderators are users of the IdeaSpace who are granted access to the posts and threads of all members for the purpose of moderating discussion (similar to arbitration) and also keeping the IdeaSpace clean (neutralizing spam, advertising, etc.). Moderators also answer users' concerns about the IdeaSpace, general questions, as well as respond to specific complaints. Common privileges of moderators include: deleting, merging, moving, and splitting of posts and threads, locking, renaming, “sticky-ing” of threads, banning, suspending, unsuspending, unbanning, warning the members, or adding, editing, removing the polls of threads.

Essentially, the moderator manage the day-to-day affairs of an IdeaSpace as it applies to the stream of user contributions and interactions. The relative effectiveness of this user management directly impacts the quality of an IdeaSpace in general, its appeal, and its usefulness as a community of interrelated users.

Administrator

The administrators manage the technical details required for running the site/user interface of the system 100. As such, they may promote (and demote) members to/from moderators, manage the rules, and sub-sections. Administrators can also act as moderators. Administrators may also make IdeaSpace-wide announcements, or change the appearance (the skin) of an IdeaSpace.

Post

A post is a user-submitted idea enclosed into a block containing the user's details and the date and time it was submitted (this date/time stamp is critical). Posts are contained in threads, where they appear as blocks one after another. The first post starts the thread; this may be called the TS (thread starter) or OP (original post). Posts that follow in the thread are meant to continue discussion about that post, or respond to other replies; it is not uncommon for discussions to be derailed so the job of the moderator is to control discussion to ensure relevancy.

The classic way to show a member's own details (such as name and avatar) has been on the left side of the post, in a narrow column of fixed width, with the post controls located on the right, at the bottom of the main body, above the signature block. In more recent message board software implementations, the Asian style of displaying the members' details above the post has been copied. TDB. We should consider pros and cons of both.

Posts may have an internal limit measured in characters. Often one is required to have a message of minimum length of 10 characters. There is always an upper limit but it is rarely reached—most boards have it at either 10,000, 20,000, 30,000, or 50,000 characters.

The IdeaSpace may keep track of a user's postcount. The postcount is a measurement of how many posts a certain user has made. Users with higher postcounts are often considered more reputable than users with lower postcounts, but not always. This will contribute to the Achievement (see Achievement and Title requirement document).

Thread

A thread (sometimes called a topic) is a collection of posts, usually displayed from oldest to latest, although this be configurable: Options for newest to oldest and for a threaded view (a tree-like view applying logical reply structure before chronological order) may be available. A thread is defined by a title, an additional description that may summarize the intended discussion, and an opening or original post (common abbreviation OP, which can also mean original poster), which opens whatever dialogue or makes whatever announcement the poster wished. A thread can contain any number of posts, including multiple posts from the same members, even if they are one after the other.

A thread is contained in an IdeaSpace, and may have an associated date that is taken as the date of the last post (options to order threads by other criteria should be available). When a member posts in a thread it will jump to the top since it is the latest updated thread. Similarly, other threads will jump in front of it when they receive posts. When a member posts in a thread for no reason but to have it go to the top, it is referred to as a bump or bumping. TBD. Bumping should be limited (e.g., 3 bumps).

Threads that are important but rarely receive posts are sticky-ed (or “pinned”). A sticky thread will always appear in front of normal threads, often in its own section. For the system 100, a Sticky-ed or Pinned Thread is shown as “Manager's Choice” to the side of the IdeaSpace. Alternatively, it is shown as “Featured Threads” for that IdeaSpace.

A thread's popularity is measured on IdeaSpaces in reply, liked, followed, viewed, search result counts. Some IdeaSpaces also track page views. Threads meeting a set number of posts or a set number of views may receive a designation such as “hot thread” and be displayed with a different icon compared to other threads. This icon/background (or some kind of indication, including featuring it) may stand out more to emphasize the thread. If the IdeaSpace's users have lost interest in a particular thread, it becomes a dead thread.

Private Message

A private message, or PM for short, is a message sent in private from a member to one or more other members. Private messages are generally used for personal conversations.

Attachment

An attachment can be almost any file. When a user attaches a file to a post they are uploading the file to the IdeaSpace's server.

Links

A link can be insert to any post. The system 100 may scrape and summarize the link and provide a short description and image if available. See how Podio and Linkedin implements link.

Emoticon

An emoticon or smiley is a symbol or combination of symbols used to convey emotional content in written or message form.

Poll

IdeaSpace may implement an opinion poll system for threads. For example, IdeaSpace may allow for single-choice or multi-choice (sometimes limited to a certain number) when selecting options as well as private or public display of voters. Polls can be set to expire after a certain date or in some cases after a number of days from its creation. Members vote in a poll and a statistic is displayed graphically.

Rules and Policies on IdeaSpaces

IdeaSpaces may be governed by a set of individuals, collectively referred to as staff, made up of administrators and moderators, which are responsible for the IdeaSpaces' conception and policies (creation and enforcing). The administrator or moderator may create a list of rules detailing the wishes, aim and guidelines of the IdeaSpaces' creators.

Word Censor

A word censoring system may be included in IdeaSpace. The system 100 may pick up words in the body of the post or some other user-editable IdeaSpace element (like user titles), and if they partially match a certain keyword (commonly no case sensitivity) they will be censored. The most common censoring is letter replacement with an asterisk character. For example, in the user title, it is deemed inappropriate for users to use words such as “admin”, “moderator”, “leader” and so on. If the censoring system is implemented, a title such as “IdeaSpace leader” may be filtered to “IdeaSpace ******”. Rude or vulgar words are common targets for the censoring system.

Referral

A referrer system should be implemented. A referrer is someone who introduced or otherwise “helped someone” with the decision to join either PZ or the IdeaSpace within the system 100. This action is tracked and points are assigned (see Achievements). Referrers are other IdeaSpace members and members are rewarded for referrals. The purpose is give credit to those who help the community grow.

As shown in FIGS. 6B-6C, the IdeaSpace may include an Idea Builder where a user may enter an idea description (editable), the Idea Map, and an ability to link and unlink to other ideas (suggested links). Key Words may be entered to identify the idea. A sandbox is provided hold the idea. A Team Builder option provides the ability to add or drop team members. Invite by entering email address and name of individuals. The system 100 may send an email invitation. Next, the invitee clicks link in the email to go to registration page. Once he/she registers and logs in, he/she is taken to the idea page they were invited to. Dropping team members sends an email that they were dropped from the team, but that they are still a full member of PatentZilla. Roles of the team members may be managed, Ability to view or access team members' activity and/or latest activity. Ability to see when team members were last logged on (like Podio). Thumbnail pictures of team members.

File Manager

The file manager allows users to upload files into a sandbox holding and viewing area (so all team members can access them). User may then add any files from the holding area to the idea builder. Users can delete files from the holding area. Ability to browse and add files. Users can add reference links to the sandbox area. Ability to browse to add links.

Challenge Browser

As shown in FIG. 6A, challenges may be proposed for consideration for the team. Ability to tag challenges as “relevant” even if they are not the primary challenge the team is working on. Tagged challenges appear under “relevant challenges” only if one or more has been indicated.

Activity Stream

An activity stream shows all activity related to this idea or Think Tank. The Activity stream shows all comments related to an idea or Think Tank. Team members may comment. Team members' comments are invisible to others unless they have been made “public” by the team lead. For non-team members, they can comment, but can only see team comments if they have been made public.

Once an idea has been published or submitted for patent, activity and comments prior to submission are invisible to anyone but the team. Only new activity and comments are visible to anyone with permission to view the idea.

Crowdsourcing

The process of creating value by tapping into groups of people. A distributed problem-solving and production model. FIG. 7 illustrates a process by which crowdsourcing may be used to aggregate and sell portfolios to companies or other perspective purchasers. At 702, strategic companies and/or fields of technology are targeted. For example, gaming technologies may be targeted. At 704, roadmaps are published, as discuss above with reference the roadmap tool 308 to define the technology path associated with the targeted field of technology. At 706, the “crowd” begins to submit invention disclosures related to the roadmaps. At 708, the submitted disclosures are aggregated and offered at 710 to, e.g., perspective buyers who would be interested in the technology. Crowdsourcing takes advantage of the principal that the real value of patents rests in their aggregation in the patent portfolio. As the portfolio size increases, reliance on individual patent decreases. Reduce marginal costs to realize additional net gains.

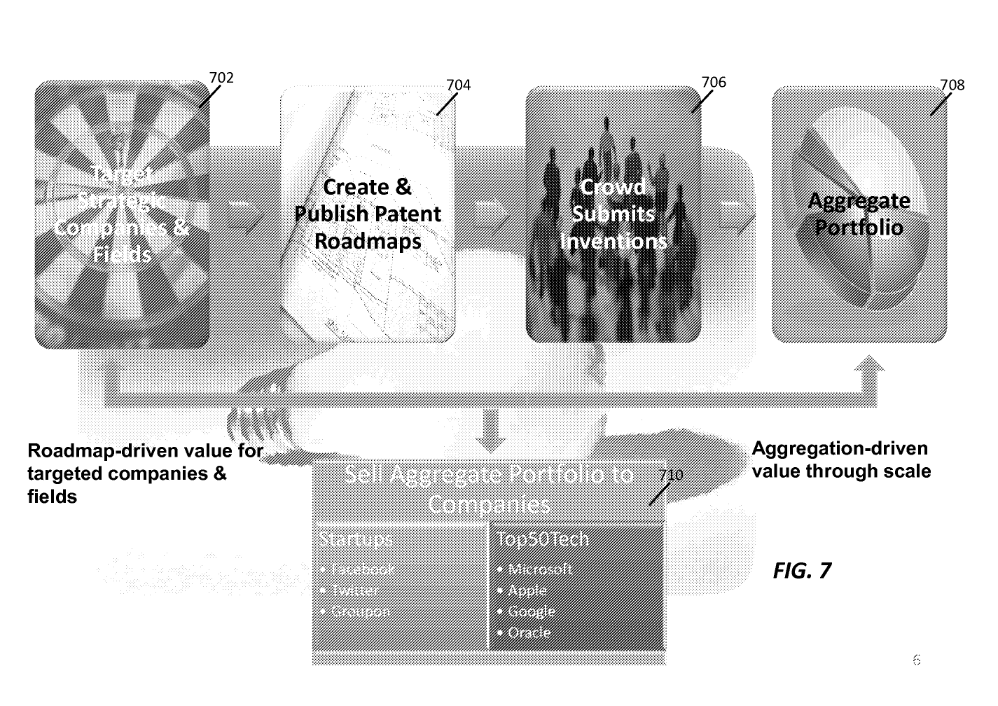

FIGS. 8-13, 14A and 14B illustrate example user interfaces associated with the system 100. FIG. 8 illustrates an example invention submission webpage 800 that may be provided to the user at 442 and/or 502. As shown, invention submission webpage 800 includes fields where the user may enter a title, description, inventor name, and or upload any attachments associated with the invention submission. As the user enters and/or uploads attachments to the system 100, tags and keywords may be identified and displayed to the user. The tags may be selected or entered by the user to better identify the submission to other users of the system 100, thus making it more discoverable.

FIG. 9 illustrates an example idea stitching user interface 900, wherein a user may indicate that other ideas (shown center left in the interface 900) are related to the user's submission. An idea map 902 may be shown to visually represent related ideas to that submitted by the user. A more detailed description of the idea map 902 is provided below. The user may indicate which of the other ideas are related by using checkboxes, and clicking the continue button in the user interface 900.

As described above, the IdeaMap 902 is used as part of the IdeaSpace as a knowledge management feature that aids in aggregating content and ideas, from both internal and external sources; classifies content and ideas using company specific taxonomies; and searches for content, ideas, and experts.

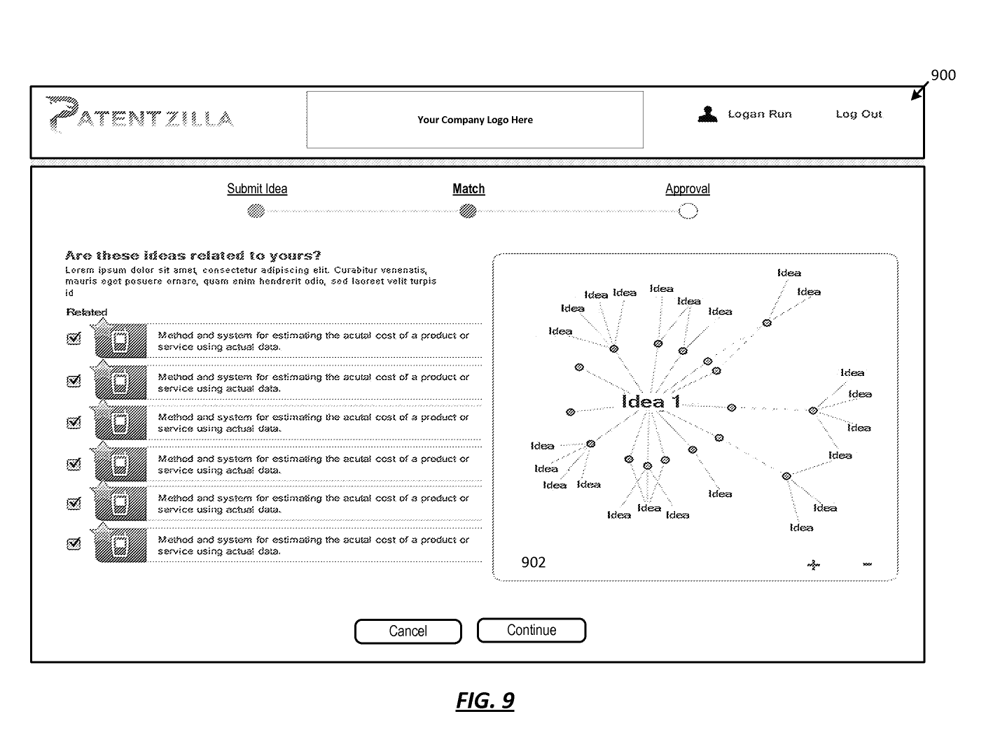

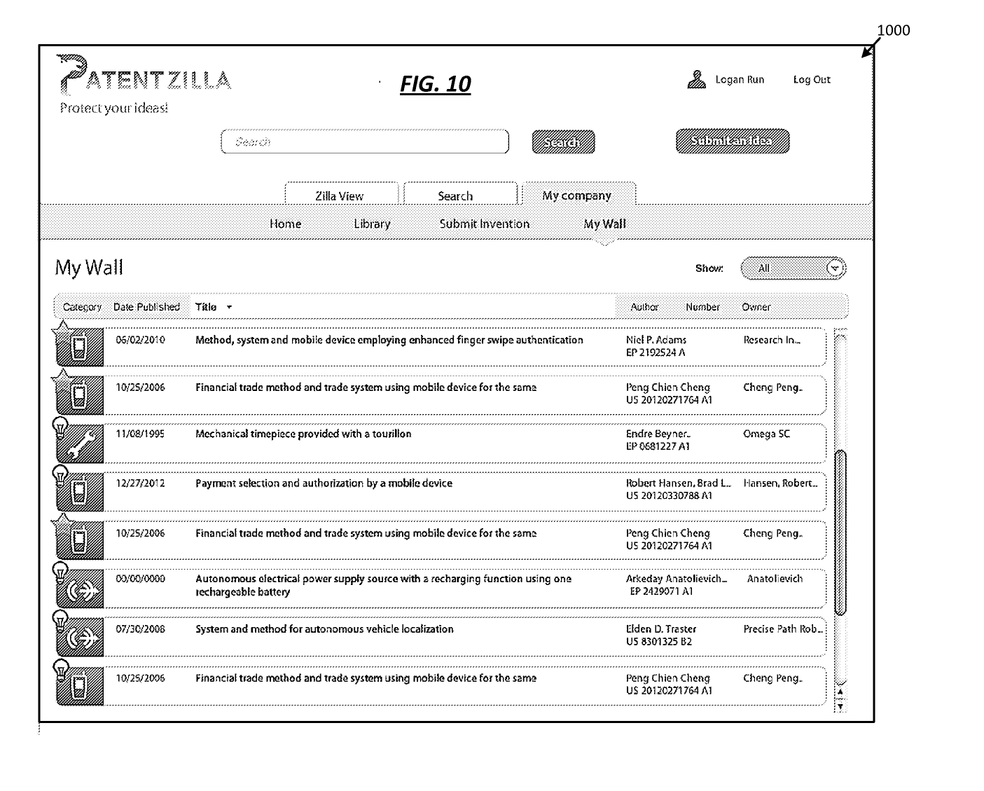

FIG. 10 illustrates an example “My Wall” user interface 1000. The “My Wall” user interface 1000 presents all of the user's submitted invention disclosures or other publications, as well as invention disclosures and publications of others that are related to the user's submissions and publications. “My Wall” user interface 1000 may also be used by a user to follow other users' submissions.

FIG. 11 illustrates a patents user interface 1100. The patents user interface 1100 displays information about patents and applications in an organized fashion. The patents user interface 1100 further includes the idea map 902, which demonstrates those ideas which are related to the displayed patent 1102. An activity feed 1104 shows activity associated with the displayed patent 1102, such as those users who are watching and commenting on the displayed patent 1102. The activity feed 1104 also displays applications and/or patents that cite or reference the displayed patent 1102.

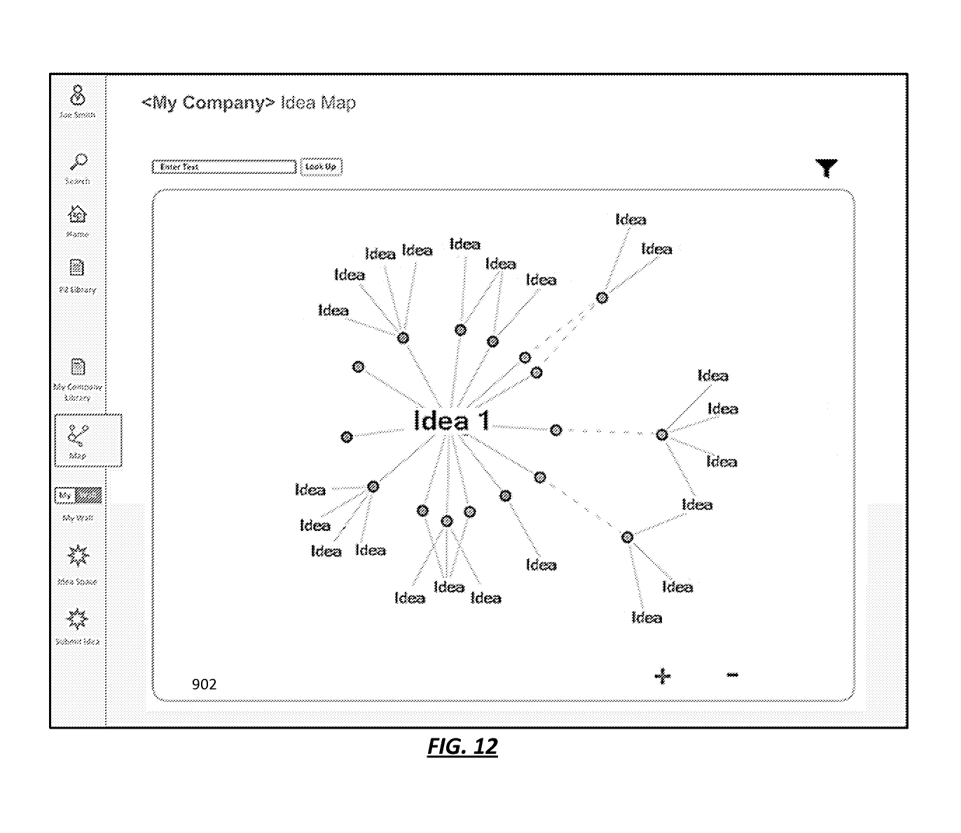

FIG. 12 illustrates the idea map 902 in greater detail. The idea map 902 provides a visualization of the relationships of the ideas stored within the system 100 to make the relationships of the data more apparent to the user. The visualization of the idea map 902 may be generated using the Thinkmap SDK, available from Thinkmap, Inc.

FIG. 13 illustrates an example search input and result user interface 1200. Searches may be entered into a quick search box 1302 and the results displayed in a search results area 1304. The results may be sorted based on criteria, such as, a category, a technology, and industry, a company, a user or individual, a date range, etc.

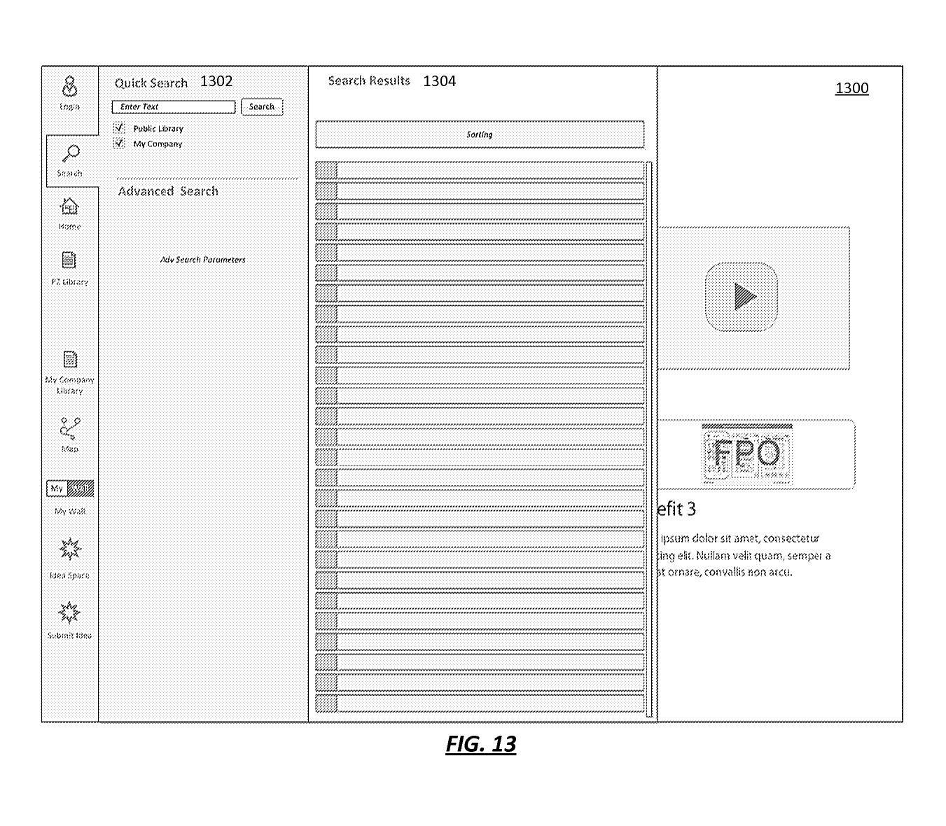

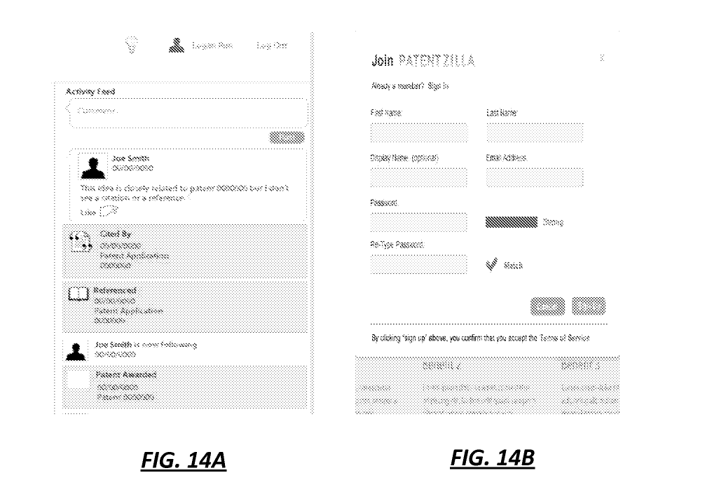

FIGS. 14A and 14B illustrate example mobile interfaces that illustrates the display on a mobile device, such as an IPHONE or ANDROID device.

Code Analysis, Repository and Services

Code Mall

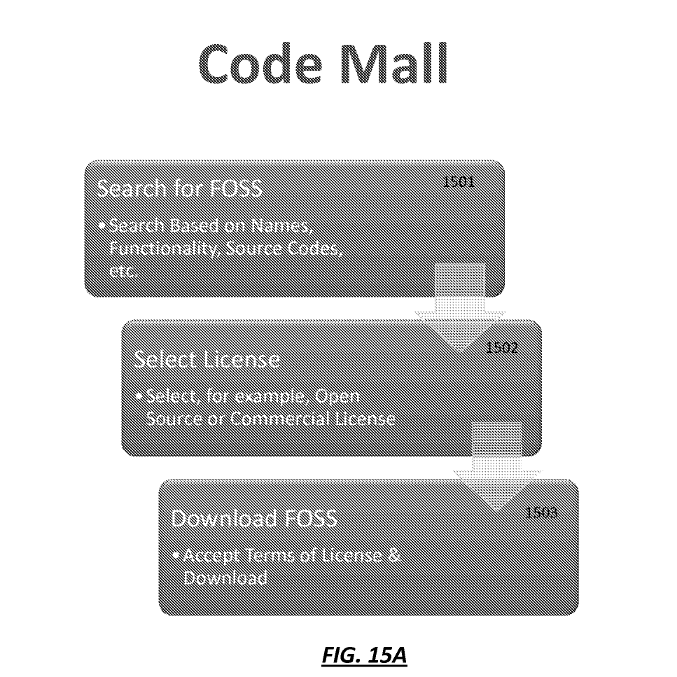

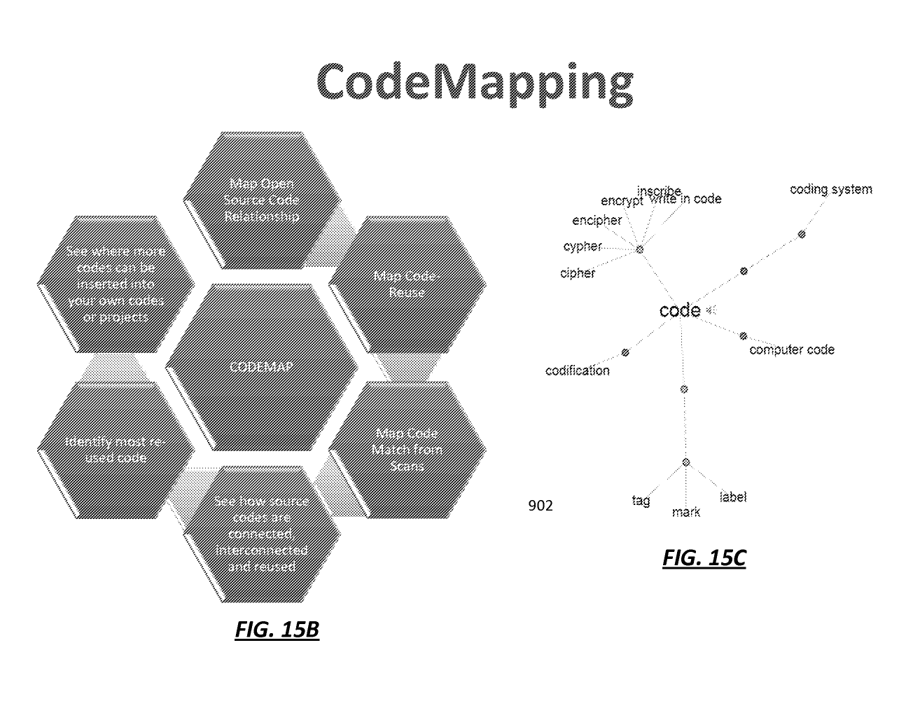

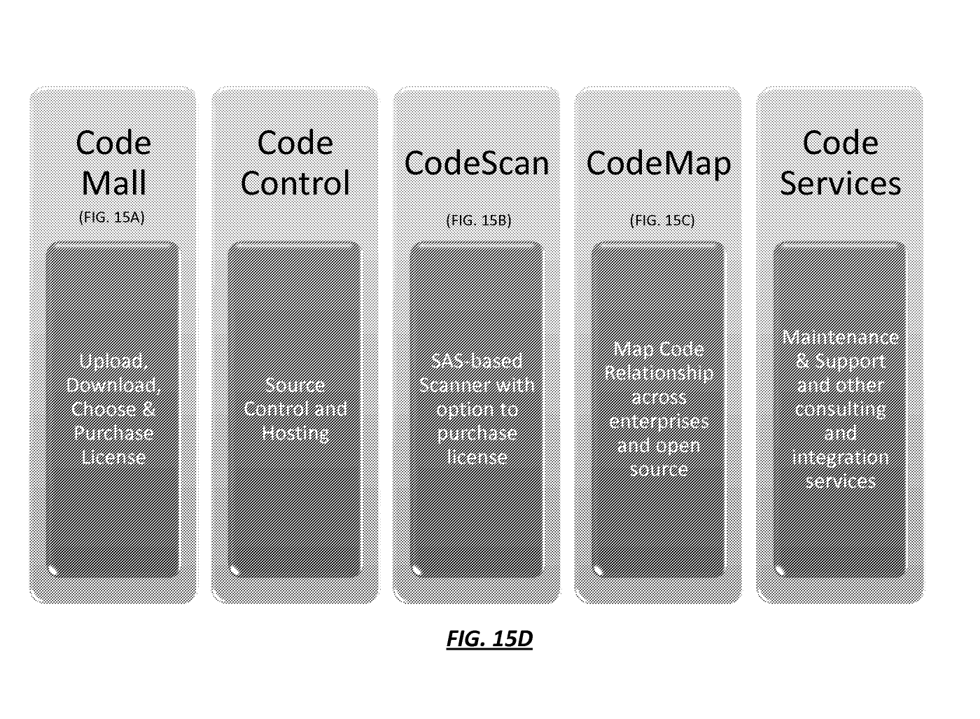

With reference to FIGS. 15A-15D, one of the frameworks of the system 100 is management of open source software based on, e.g., copyleft provisions; an option to purchase commercial licenses; and attribution requirements of open source and other licenses. The system 100 will perform functions, such as scanning open source and licenses through a mechanism that allows developers to upload code and licenses (1501). For example, with reference to FIGS. 15B and 15C, the code may be scanned for instances of open source software, scanned based on other source code by looking at other related code, the ability to reuse of the code, and other criteria (e.g., a relative proximity of code to the code being scanned). A categorization and summary of risks based on a classification system may be provided in accordance with U.S. Pat. No. 8,359,655.

The system 100 will allow the purchase of commercial license to enable a developer to switch from an Open Source License to a Commercial License (1502). For example, the system 100 may show a code match (line by line), recommend corrective actions (e.g., removal, alternatives or commercial), comply with license requirements and obligations (e.g., attribution), and provide for source code control. At 1503, a new license may be applied to the software upon acceptance by the user.

As shown in FIG. 15D, other options may be provide by the system 100, such as code control (e.g., hosting) and code services (e.g., maintenance, support and consulting).

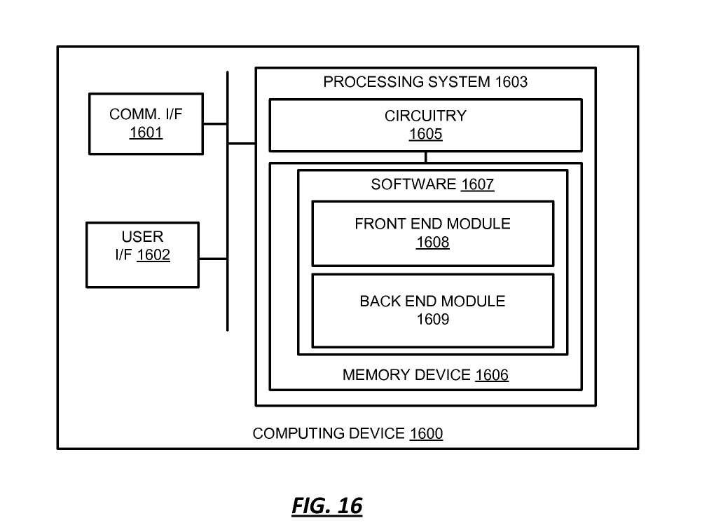

FIG. 16 illustrates a computing device 1600. Computing device 1600 can include computer(s), processor(s), wireless devices, portable devices, and/or display devices, and/or combinations thereof, although alternative configurations are also included. Computing device 1600 comprises communication interface 1601, user interface 1602, and processing system 1603. Processing system 1603 is linked to communication interface 1601 and user interface 1602. Processing system 1603 includes processing circuitry 1605 and memory device 1606 that stores operating software 1607. Computing device 1600 may include other well-known components such as a battery and enclosure that are not shown for clarity. Computing device 1600 may be a telephone, computer, e-book reader, mobile Internet appliance, media player, game console, wireless network interface card, or some other processing device—including combinations thereof.

Communication interface 1601 comprises components that communicate over communication links, such as network cards, ports, RF transceivers, processing circuitry and software, or some other communication devices. Communication interface 1601 may be configured to communicate over metallic, wireless, or optical links. Communication interface 1601 may be configured to use TDM, IP, Ethernet, optical networking, wireless protocols, communication signaling, or some other communication format—including combinations thereof.

User interface 1602 comprises components that interact with a user to receive user inputs and to present media and/or information. User interface 1602 may include a speaker, microphone, buttons, lights, display screen, touch screen, touch pad, scroll wheel, communication port, or some other user input/output apparatus—including combinations thereof. User interface 1602 may be omitted in some examples.

Processing circuitry 1605 comprises microprocessor and other circuitry that retrieves and executes operating software 1607 from memory device 1606. Memory device 1606 comprises a non-transitory storage medium, such as a disk drive, flash drive, data storage circuitry, or some other memory apparatus. Processing circuitry 1605 is typically mounted on a circuit board that may also hold memory device 1606 and portions of communication interface 1601 and user interface 1602. Operating software 1607 comprises computer programs, firmware, or some other form of machine-readable processing instructions.

Operating software 1607 includes front end module 1608 and back end module 1609. Operating software 1607 may further include an operating system, utilities, drivers, network interfaces, applications, or some other type of software. When executed by processing circuitry 1605, operating software 1607 directs processing system 1603 to operate computing device 1600 as described herein.

In particular, front end module 1608 can direct processing system 1603 to receive disclosures and route them into the patent aggregation process, and back end module 1609 can route the disclosure through the patenting process.

Front end module 1608 may be part of the operating system of computing device 1600, the application installed on computing device 1600, a different application on computing device 1600, or some other independent software component. Though shown separately, back end module 1609 may be incorporated into front end module 1608.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What it claimed:

1. A non-transitory computer readable medium having instructions stored thereon for operating a computing device, wherein the instructions, when executed by the computing device, direct the computing device to:
receive an indication from a user to create an IdeaSpace;
populate the IdeaSpace with information relate to a submission, the submission being related to a technological field;
receive comments from others regarding the submission;
map the submission to other submissions, the map showing a relative closeness of the submission the other submissions; and
publish the submission is classified as public.
